(19) United States
(12) Patent Application Publication
(10) Pub. No.: US 2022/0176489 A1
(43) Pub. Date: Jun. 9, 2022

(54) MANUFACTURING APPARATUS AND METHOD OF MANUFACTURING A METAL-COMPOSITE PATCH PART

(71) Applicants: HYUNDAI MOTOR COMPANY, Seoul (KR); KIA CORPORATION, Seoul (KR)

(72) Inventors: Junyeong Jeong, Seoul (KR); Youn Il Jung, Seoul (KR)

(73) Assignees: HYUNDAI MOTOR COMPANY, Seoul (KR); KIA CORPORATION, Seoul (KR)

(21) Appl. No.: 17/373,624

(22) Filed: Jul. 12, 2021

(30) Foreign Application Priority Data
Dec. 7, 2020 (KR) 10-2020-0169604

(51) Int. Cl. B23K 26/08; B23K 26/362; B23K 26/352; B23K 26/0622

(52) U.S. Cl. CPC B23K 26/0853; B23K 26/362; B23K 2103/18; B23K 26/0622; B23K 26/355

(57) ABSTRACT

A manufacturing apparatus of a metal-composite patch part and a manufacturing method thereof include: a laser oscillator oscillating a laser; a first laser irradiator used to perform pattern processing on one surface of a metal with a laser by receiving the laser from the laser oscillator; and a metal-composite bonding apparatus for bonding a composite tape to the one surface of the pattern-processed metal. The apparatus includes a feeder roller supplying a composite tape to the one surface of the pattern processed metal and a pressing roller pressing the composite tape to the one surface of the metal. The bonding performance between the metal and the composite and productivity may be improved because the number of the processes related to the metal-composite patch part manufacturing process may be significantly reduced.

### CROSS-REFERENCE TO RELATED APPLICATION

This application claims priority to and the benefit of Korean Patent Application No. 10-2020-0169604 filed in the Korean Intellectual Property Office on Dec. 7, 2020, the entire contents of which are incorporated herein by reference.

### BACKGROUND

### (a) Field of the Disclosure

The present disclosure relates to a manufacturing apparatus and a method for manufacturing a metal-composite patch part. More particularly, the present disclosure relates to a manufacturing apparatus and a method of manufacturing a metal-composite patch part capable of increasing productivity by applying automated fiber placement (AFP) equipment, which is a composite part manufacturing technology.

### (b) Description of the Related Art

To enhance fuel efficiency of internal combustion engine vehicles and improve a range of electric and hydrogen vehicles, vehicle body weight reduction continues to be an issue in the vehicle industry. In order to reduce the weight of the vehicle body, an ultra-high-strength steel sheet with improved strength compared to a previous one may be used. However, there is a limit to the application of the ultra-high-strength steel sheet alone to secure performance.

Therefore, the application of lightweight metals such as aluminum is increasing. Furthermore, the application of composites such as carbon fiber reinforced plastics (CFRP), which are lighter than metals, is being considered. However, in the case of the composite, though the weight is light, the price is high, and there is a problem in which the bonding with the metal is difficult. Therefore, technologies that locally apply composites only to areas requiring the performance reinforcement are being developed. Among them, a representative technique is a method of attaching a CFRP reinforcement material to a steel center pillar through a thermal pressurization method (hot stamping). The method of integrating and curing a cut pre-impregnated material, i.e., a prepreg with an adhesive film requires about 15 processes. These processes may include prepreg cutting, prepreg transfer, post-transfer position tolerance determination, prepreg lamination, label attachment, laminated plate cutting, scrap punching with a scrap mold, laminate transfer, adhesive film cutting, inspection of an adhesive film dimension/position, loading and pressing of a laminated plate on an adhesive film, a consolidation process, delivery after a packaging, mold transfer of a hot stamping center pillar outer and a CFRP center pillar reinforcement material, simultaneous curing of an adhesive film and a laminated plate, and the like. Thus, the productivity is very low.

Therefore, the application of a steel-composite patch part manufacturing technology that may increase the productivity compared to the prior art by applying automated fiber placement (AFP) equipment, which is one of the composite component manufacturing methods, is being developed. However, the following problems exist in applying the AFP equipment to the metal composite.

Simultaneous heating is not possible due to the difference in thermal characteristics of the metal and the composite. Also, when a small amount of heat is applied, the composite may be heated sufficiently, but the metal may not be heated. Conversely, when a large amount of heat is applied, the composite burns or deforms, and the bonding with the metal is impossible. Therefore, there is a problem in which the bonding force is insufficient due to the difference in surface characteristics of the metal and the composite.

The present disclosure was devised to solve the above problem.

The above information disclosed in this Background section is only to enhance understanding of the background of the disclosure. Therefore, the Background section may contain information that does not form the prior art that is already known in this country to a person having ordinary skill in the art.

### SUMMARY

An embodiment of the present disclosure provides an apparatus capable of simultaneously heating a metal and a composite for bonding of the metal and the composite. Embodiments of the present disclosure also provide a manufacturing apparatus and a method of manufacturing a metal-composite patch part capable of increasing an adherence with the composite by applying a pattern to a metal surface using a laser to increase a surface area to be bonded to the composite and of improving a mechanical interlocking effect through a pattern shape.

A manufacturing apparatus of a metal-composite patch part according to an embodiment of the present discloses includes: a laser oscillator oscillating a laser; a first laser irradiator used to perform pattern processing on one surface of a metal with a laser by receiving the laser from the laser oscillator; and a metal-composite bonding apparatus for bonding a composite tape to one surface of the pattern-processed metal. The metal-composite bonding apparatus includes a feeder roller supplying a composite tape to one surface of the pattern processed metal and includes a pressing roller pressing the composite tape to one surface of the metal.

The laser may be a pulse laser.

The shape of one surface of the metal according to the pattern processing may be defined according to the output of the laser and/or the pattern processing speed of the first laser irradiator.

The output of the first laser may be 70 W or more and 120 W or less.

The pattern processing speed of the first laser irradiator may be 700 mm/s or more and 1000 mm/s or less.

The metal-composite bonding apparatus may further include a composite heating device for heating the composite tape before pressing the composite tape to one surface of the metal.

The composite heating device may be a Xenon beam.

The composite tape may be a composite tape including more than 40% by weight and less than 100% by weight of a carbon fiber reinforced plastic (CFRP) relative to an entire weight thereof.

A second laser irradiator for pre-heating an opposite surface of the metal pattern-processed by receiving the laser oscillated from the laser oscillator may be further included.

A manufacturing method of a metal-composite patch part according to another embodiment of the present disclosure includes: transmitting a first laser from a laser oscillator to a first laser irradiator; irradiating a first laser while moving the first laser irradiator on one surface of a metal for performing pattern processing to one surface of the metal; and bonding a composite tape on one surface of the pattern-processed metal. The composite tape is supplied to one surface of the metal through a feeder roller and the composite tape is pressed to one surface of the metal through a pressing roller.

The first laser may be a pulse laser.

The output of the first laser may be controlled to 70 W or more and 120 W or less.

The pattern processing speed of the first laser may be controlled to be 700 mm/s or more and 1000 mm/s or less.

Before pressing the composite tape to one surface of the metal through the pressing roller, the composite tape may be heated by using a composite heating apparatus.

The composite heating apparatus may be a Xenon beam.

The composite tape may be a composite tape including more than 40% by weight and less than 100% by weight of a CFRP relative to an entire weight thereof.

Pre-heating an opposite surface to one surface of the pattern-processed metal by receiving a second laser oscillated from the laser oscillator from a second laser irradiator may be further included.

In the preheating, the position of the second laser irradiator may be adjusted to irradiate the second laser at a distance of 0 mm or more and 10 mm or less from the center of the pressurized roller.

According to an embodiment of the present disclosure, bonding performance between the metal and the composite may be improved.

In addition, the number of processes related to the manufacturing process of the metal-composite patch part may be significantly reduced.

In addition, it is possible to reduce a manufacturing cost and reduce a weight of the parts.

Through this, the productivity of the metal-composite patch part used in the vehicle may be comprehensively improved.

Further, effects that can be obtained or expected from embodiments of the present disclosure are directly or suggestively described in the following detailed description. In other words, various effects expected from embodiments of the present disclosure are described in the following detailed description.

### BRIEF DESCRIPTION OF THE DRAWINGS

FIG. 1 is a schematic diagram of a metal-composite patch part manufacturing apparatus according to an embodiment of the present disclosure.

FIG. 2 is a view showing a configuration of a metal-composite patch part manufacturing apparatus according to an embodiment of the present disclosure.

FIG. 3 is a view showing a configuration of a metal-composite patch part manufacturing apparatus according to another embodiment of the present disclosure.

FIG. 4 is a view showing a configuration of a metal-composite patch part manufacturing apparatus according to another embodiment of the present disclosure.

FIG. 5 is a view showing a manufacturing method of the metal-composite patch part according to an embodiment of the present disclosure.

FIG. 6 is a view showing a manufacturing method of the metal-composite patch part according to another embodiment of the present disclosure.

FIG. 7 is a view showing a manufacturing method of the metal-composite patch part according to another embodiment of the present disclosure.

FIG. 8 is a view showing a manufacturing method of the metal-composite patch part according to a modified embodiment of the present disclosure.

FIG. 9 is a view showing a manufacturing method of the metal-composite patch part to which an additional process is added according to a modified embodiment of the present disclosure.

FIG. 10 is a view showing a result of a shear tensile test of a metal-composite patch part according to a presence or absence of preheating of a metal according to an embodiment of the present disclosure.

FIG. 11 is a view showing pattern processing of a metal surface according to a first laser output and speed according to an embodiment of the present disclosure.

FIG. 12A is a table obtained by measuring bending strength and bending energy of a metal-composite according to an embodiment of the present disclosure.

FIG. 12B is a graph obtained by measuring bending strength and bending energy of a metal-composite according to an embodiment of the present disclosure.

FIGS. 13A-13D are views showing examples of vehicle parts applied with a manufacturing method according to an embodiment of the present disclosure.

### DETAILED DESCRIPTION OF THE EMBODIMENTS

The terms used herein are for the purpose of describing specific embodiments only and are not intended to limit the present disclosure. As used herein, singular forms are intended to also include a plurality of forms, unless the context clearly indicates otherwise. The terms “comprise” and/or “comprising”, when used in the present specification, specify the presence of the mentioned features, integers, steps, operations, constituent elements, and/or components, but it should also be appreciated that at least the presence or addition of other features, integers, steps, operations, constituent elements, components, and/or groups thereof is not excluded. As used herein, the term “and/or” includes any one or all combinations of the items listed in association.

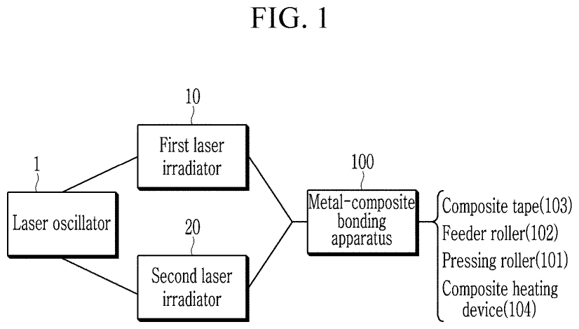

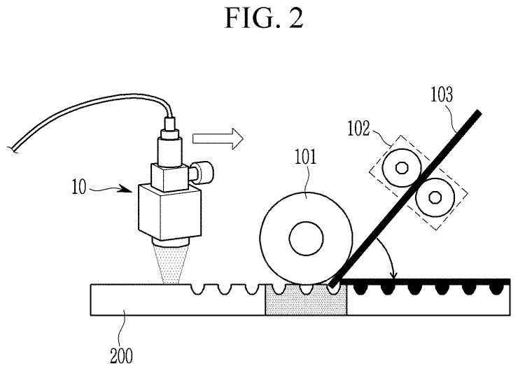

FIG. 1 is a schematic diagram of a metal-composite patch part manufacturing apparatus according to an embodiment of the present disclosure. FIG. 2 is a view showing a configuration of a metal-composite patch part manufacturing apparatus according to an embodiment of the present disclosure.

Hereinafter, for convenience of description, steel is used as a metal material, but the type of the metal is not limited to steel. FIG. 1 and as shown in FIGS. 2-4, a metal-composite patch part manufacturing apparatus includes a laser oscillator 1, a first laser irradiator 10, a second laser irradiator 20, and a metal-composite bonding apparatus 100.

The first and second laser irradiators 10 and 20 are connected to one laser oscillator 1 to receive a laser oscillated from the laser oscillator 1 and irradiate the first and second lasers to the metal 200, respectively. Here, the first laser irradiator 10 is used for pattern processing of the metal 200 surface and the second laser irradiator 20 is used to preheat the metal 200 before metal-composite bonding. In this embodiment, the first and second laser irradiators 10 and 20 are connected to one laser oscillator 1, but the present disclosure is not limited thereto. The first and second laser irradiators 10 and 20 may be connected to one of two laser oscillators 1 and the other, respectively.

Through the laser oscillator 1, the output may be adjusted differently by controlling each current and voltage in relation to the oscillation of the first laser and the oscillation of the second laser. In addition, each of the first laser and second laser may be controlled in a form of a pulse laser.

As shown in FIG. 2, a metal-composite patch part manufacturing apparatus according to an embodiment may include a laser oscillator 1, a first laser irradiator 10, and a metal-composite bonding apparatus 100.

In this case, a pulse laser may be used as the first laser. The use of the laser is largely divided into pulse surface processing, heating, and welding, etc., because it is easy to use the pulse laser for the surface processing. The pulse laser is in contrast to a continuous wave laser. Since an oscillation and stop are repeated, temporal focusing of energy may be greatly increased and the irradiation area is wider than other lasers.

In addition, it has an intrinsic wavelength that is different from other lasers including diode lasers. As an example, the pulse laser has a wavelength of more than 10 times longer than the diode laser. Therefore, even if the laser of the same speed is irradiated, less energy per unit area is irradiated due to the relatively long wavelength. If the total amount of energy to be irradiated is the same, it is possible to irradiate the wider area than with other lasers, so relatively less energy per unit area is irradiated.

As an example, when steel is selected as the metal 200 and a carbon fiber reinforced plastic (CFRP) is selected as the composite, the output of the first laser that is oscillated by the laser oscillator 1 and irradiated to the metal 200 surface through the first laser irradiator 10 may be 70 W or more and 120 W or less.

If the output of the first laser is less than 70 W, the generation of a protrusions and depressions structure may be insignificant when performing pattern processing on the metal 200 surface. When it exceeds 120 W, a thermal deformation may be generated on the metal 200 surface when performing the pattern processing on the metal 200 surface. Thereby, it is difficult to be bonded with the composite.

Also, the pattern processing speed of the first laser irradiator 10 is controlled. The pattern processing speed refers to a speed at which the first laser irradiator 10 passes parallel on the surface of metal 200 to pattern-process the surface of the metal 200. At this time, the metal 200 may be fixed in place without moving. Surface pattern processing is performed by irradiating the first laser while the first laser irradiator 10 passes in parallel on the surface of the fixed metal 200.

At this time, the shape of the protrusions and depressions formed on the surface may vary according to the waveform of the first laser. When a displacement caused by the wave periodically repeats a certain shape, the repeated unit, i.e., the shape of the displacement within one wavelength, is called a waveform. Accordingly, since the stimulation intensity of the first laser that is temporarily irradiated to the surface changes depending on time, the shape of the surface protrusions and depressions may appear variously when the waveform is different.

As an example, the pattern processing speed may be 700 mm/s or more and 1000 mm/s or less. When the pattern processing speed of the first laser irradiator 10 is less than 700 mm/s, the productivity for the pattern processing may be deteriorated. When it exceeds 1000 mm/s, the generation of the protrusions and depressions structures according to the pattern processing is insignificant.

The metal-composite bonding apparatus 100 is a device that bonds a composite to the surface of the metal 200. Referring to FIGS. 2-4, the metal-composite bonding apparatus 100 includes a feeder roller 102 that supplies a composite tape 103 bonded to the metal 200 surface onto the metal 200 surface and a pressing roller 101 that presses the composite tape 103 to the metal 200 surface.

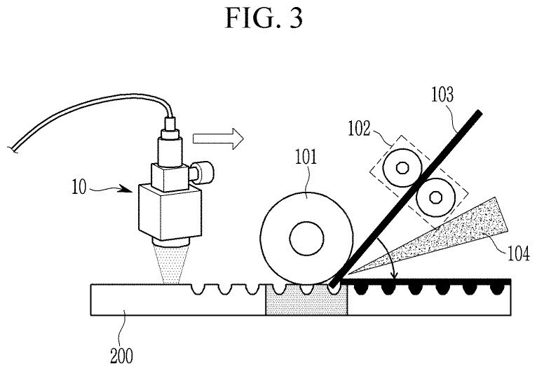

As shown in FIG. 3, the metal-composite bonding apparatus 100 may further include a composite heating device 104 for preheating the composite tape 103 before pressing the composite tape 103 to the surface of the metal 200. The composite heating device 104 allows the composite tape 103 to be smoothly bonded to the surface of the metal 200 by heating the composite tape 103 before the bonding. As an example, the composite heating device 104 may use a Xenon beam.

The reason for heating the composite tape 103 with a Xenon beam is that the wavelength range is wider than that of the laser. Thus, the Xenon beam may simultaneously heat not only the composite tape 103 but also the metal 200 surfaces, thereby improving the adherence between the composite tape 103 and the metal 200 surfaces. In addition, since the wavelength of the Xenon beam is harmless to the human body, including a visible ray region and an infrared region, there is no need to construct separate safety equipment and additional costs may be reduced.

As an example, considering the impact and strength of the metal-composite patch part, the CFRP is included at 40% or more and 100% or less for the total weight of the composite tape 103. The CFRP is a lightweight structure material with high elasticity. A carbon fiber that is a core material used as a reinforcement for the CFRP, has a tensile strength that is 10 times stronger than iron that may lift 700 kg or more with a cross-section of 1 mm². However, the weight of the carbon fiber is only a quarter of that of iron. In addition, the composite tape 103 may be a single direction (unidirectional) tape in which the carbon fibers are disposed in one direction.

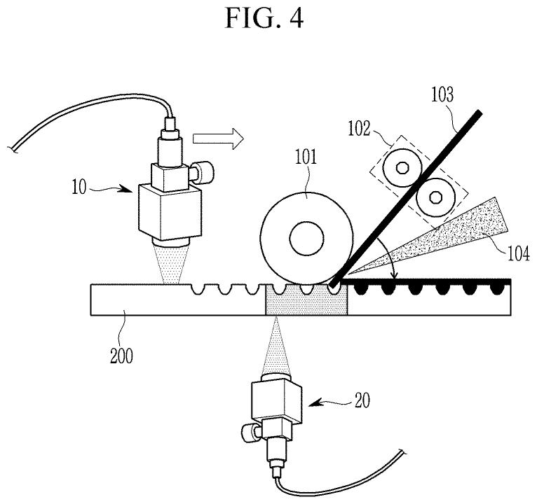

As shown in FIG. 4, the metal-composite patch part manufacturing apparatus may further include a second laser irradiator 20. The second laser irradiator 20 irradiates the second laser oscillated from the laser oscillator 1 to the surface of the metal 200 and preheats the metal 200. In the case of the second laser, the laser type is not particularly limited as it uses an induction heating principle of the laser. As an example, a pulse laser may be used for the preheating purpose and to improve the productivity of the pattern-processed metal 200.

Next, a manufacturing process of the metal-composite patch part using the manufacturing apparatus of the metal-composite patch part is described in detail. The manufacturing method of the metal-composite patch part according to an embodiment of the present disclosure is simplified, differently from a conventional art, which required a process of 10 or more steps. A detailed embodiment is described with reference to the drawings as follows.

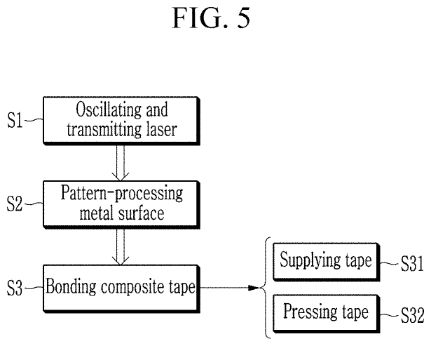

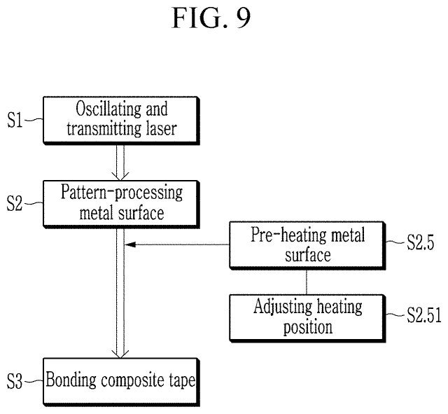

FIGS. 5-8 are views showing the manufacturing method of the metal-composite patch part according to an embodiment of the present disclosure. FIG. 9 is a view showing a manufacturing method of the metal-composite patch part to which an additional process is added according to a modified embodiment of the present disclosure.

First Step: Laser Supply Through a Laser Oscillator

The manufacturing method of the metal-composite patch part includes a step for oscillating the first laser through the laser oscillator 1 and transmitting the first laser to the first laser irradiator 10 (S1). The first laser irradiator 10 performs the pattern processing on the surface of the metal 200 by using the first laser in the following method.

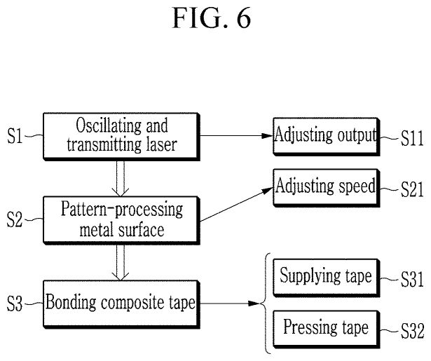

The step (S1), as shown in FIG. 6, may further include a step (S11) of adjusting the output of the laser.

As an example, when the steel is selected as the metal 200 and the CFRP is selected as the composite, the output of the first laser is required to be 70 W or more and 120 W or less, as described above. Therefore, a step of adjusting the output of the first laser to 70 W or more and 120 W or less within the first step may be added.

Depending on the waveform of the first laser, it may affect the shape of the protrusions and depressions according to the pattern processing of the surface of the metal 20. The user may change the waveform of the first laser to realize the shape of the desired protrusions and depressions on the metal 200 surface.

Second Step: Pattern Processing of a Metal Surface

The pattern processing is performed on the surface of the metal 200 where the composite is bonded by using the first laser, which is a laser for pattern-processing the metal surface (S2). In this case, a pulse laser may be used as the first laser. The first laser is irradiated onto the metal 200 surface using a first laser irradiator 10. At this time, the metal 200 may be fixed in a place without moving. The first laser irradiator 10 moves parallel to the metal 200 on the surface of the fixed metal 200 and irradiates the first laser.

The step (S2) may further include a step (S21) of adjusting the pattern processing speed of the laser. The pattern processing speed of the first laser irradiator 10 affects the shape of the protrusions and depressions generated by the pattern processing of the surface of the metal 20. As an example, when the steel is selected as the metal 200 and the CFRP is selected as the composite, the pattern processing speed of the first laser 10 within the step S21 may be adjusted to be 700 mm/s or more and 1000 mm/s or less.

Third Step: Bonding a Composite Tape to a Metal Surface

The composite is bonded to the heated metal 200. In the case of the composite, the composite tape 103 of a long stretched flat plate shape may be used. As described above, as an example, the composite tape 103 may be a tape including 40% or more and 100% or less of the CFRP among the entire weight of the tape in consideration of the impact and strength performance.

The step (S3) includes supplying the composite tape 103 in the direction of the metal 200 surface through the feeder roller 102 (S31). The feeder roller 102 is provided with a pair of each of the top and bottom based on the composite tape 103 and pushes the composite tape 103 in the surface direction of the metal 200. The composite tape 103 supplied through the feeder roller 102 is coated to the metal 200 surface. Thereafter, the applied composite tape 103 is coated by using a pressing roller 101 (S32), through which the pattern-processed metal 200 surface and the composite tape 103 are bonded to each other.

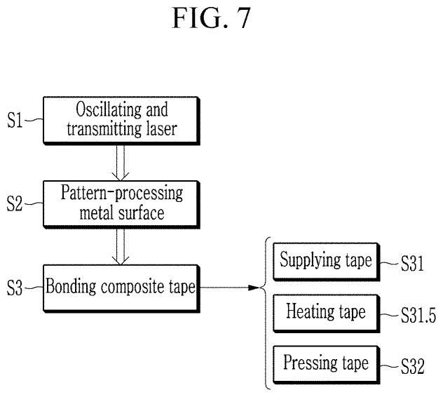

According to an embodiment of the present disclosure, as shown in FIG. 7, before pressing the composite tape 103 to the metal 200 surface by using the pressing roller 101, the composite tape 103 may be heated by the composite heating apparatus 104 (S31.5). As described above, the metal 200 surface and the composite tape 103 may be simultaneously heated and a Xenon beam may be used as the composite heating apparatus 104 to improve the adherence of the metal 200 surface and the composite tape 103.

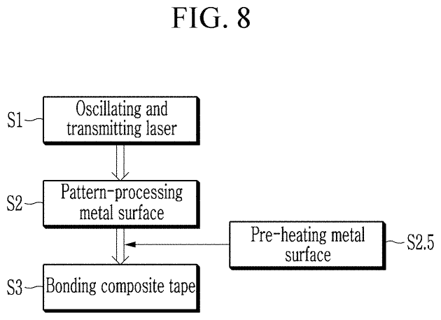

Referring to FIGS. 8 and 9, the manufacturing method of the metal-composite patch part may further include pre-heating the metal 200 of which the surface is pattern-processed between the step (S2) and the step (S3) (S2.5). When the composite and the metal 200 are bonded, if the metal 200 is sufficiently heated, the adherence of the metal 200 and the composite is reinforced. Thus, the composite may be well adhered to the protrusions and depressions of the pattern-processed metal 200 surface.

As an example, the metal is heated to about 120° C. using a second laser irradiator 20 to preheat the metal 200. Likewise, the second laser may also use a pulse laser. However, if the metal 200 is heated to a temperature of 120° C. or higher, the tensile strength is 980 MPA or higher and rapid tempering of the metal 200 occurs, so that physical properties may be deteriorated. In some embodiments, the temperature may be maintained below 120° C.

When the metal 200 is heated with the second laser, the heating position of the second laser may be the opposite surface of the cross-section where the surface is pattern-processed to avoid interference with the pressing roller 101, which is described below. In addition, when the distance between the pressing roller 101 that presses the composite on the cross-section having the pattern-processed surface and the heating position is spaced by a certain distance (e.g., 10 mm) or more, the heated metal 200 may be cooled and the adhesion performance may be lowered. Therefore, when heating the opposite surface of the pattern-processed cross-section of the metal 200, the position of the second laser irradiator 20 may be adjusted (S2.51) so as to heat the opposite surface within an interval of 0 mm or more to 10 mm or less from the center of the pressing roller 101.

In addition, according to an embodiment of the present disclosure, since the voltage and current values related to the oscillation of the first and second lasers are independently controlled through the laser oscillator 1, the output values of the first laser and the second laser may be set differently. Thus, the first laser with the relatively large output value forms the protrusions and depressions on the metal 200 surface and the second laser with the relatively small output value simply heats the metal 200.

Hereinafter, an experiment result value for each step of the manufacturing method of the metal-composite patch part according to an embodiment of the present disclosure is examined in detail.

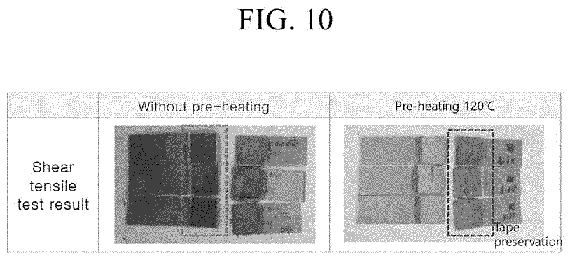

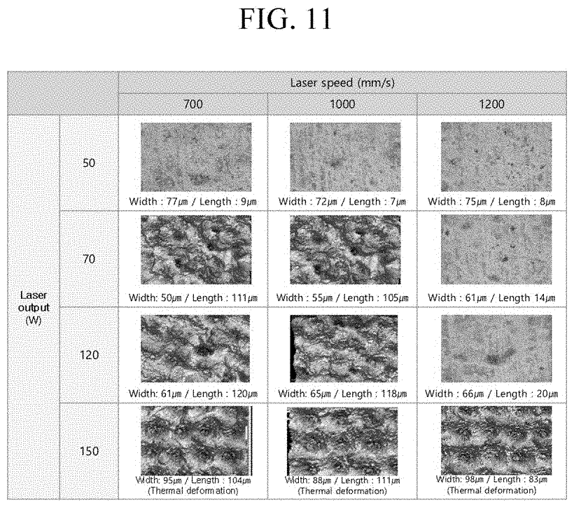

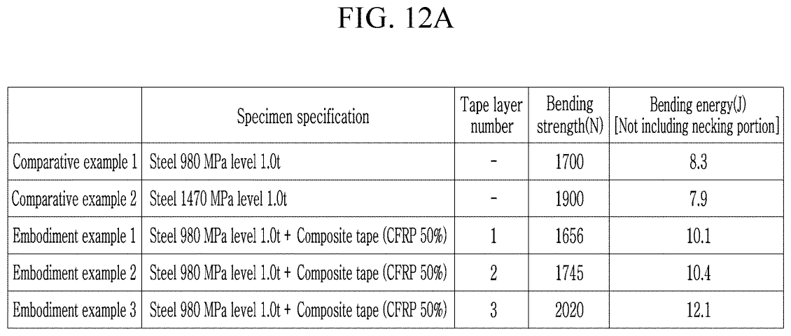

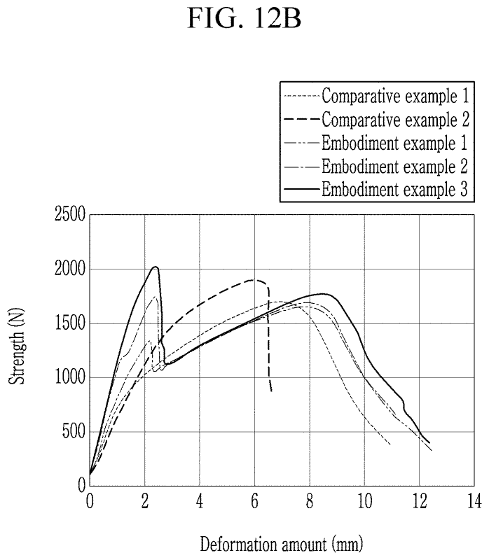

FIG. 10 is a view showing a result of a shear tensile test of a metal-composite patch part according to the presence or absence of preheating of a metal according to an embodiment of the present disclosure. FIG. 11 is a view showing pattern processing of a metal surface according to a first laser output and speed according to an embodiment of the present disclosure. FIGS. 12A and 12B are a table and graph showing data obtained by measuring bending strength and bending energy of a metal-composite according to an embodiment of the present disclosure.

For example, in the case of selecting the steel as the metal 200 and the CFRP as the composite, the pattern processing is performed on the surface of the metal 200 while changing the speed and output of the first laser. The results are as follows.

As shown in FIG. 11, in the condition where the output of the first laser was 50 W, the depth of the pattern formed on the surface of the metal 20 was less than 10 μm, indicating that there was little effect of the pattern formation. As the laser output improved from 50 W to 70 W, 120 W, and 150 W, the depth of the pattern increased.

Particularly, in the condition where the output of the first laser was 120 W, a result similar to that in the condition of 70 W was shown. In addition, when the output of the first laser was increased to 150 W, the pattern depth was about 80 μm or more and 110 μm or less, which is similar to the result of the condition where the output of the first laser was 70 W or 120 W. It may be seen that this is because, when the output of the first laser increases, the relative height difference between the patterned portion and the non-patterned portion is not increased because, not only part of the metal 200 undergoing the pattern processing, but also the surrounding portion are melted together.

In addition, it was found that, in the condition where the output of the first laser is 150 W, thermal deformation of the metal 200 occurs due to the excessive output of the first laser. The first laser output may be adjusted to 70 W or more and 120 W or less because it may cause problems such as dimensional deformation of the metal 200 through the thermal deformation as described above.

When checking the experiment value according to the pattern processing speed of the first laser irradiator 10, it was possible to secure a pattern width of about 100 μm at the pattern processing speed from 700 mm/s to less than 1000 mm/s. However, as described above, when the pattern processing speed is 1000 mm/s or more, the pattern depth is reduced to 20 μm or less due to the insufficient time for the pattern processing per a certain unit surface and the pattern processing effect is found to be insignificant. Therefore, the pattern processing speed should be adjusted from 700 mm/s or more to 1000 mm/s or less.

Next, the adherence evaluation result between the metal 200 and the composite tape 103 according to the presence or absence of the preheating for the metal 200 by the second laser is as follows. To perform the adherence evaluation, the metal 200 to which the composite tape 130 is bonded and another metal material to which an adhesive for a structure is applied are prepared. Then, the metal 200 surface to which the composite tape 103 was bonded and the surface of the metal material to which the adhesive for the structure was applied were bonded and a shear tensile test was conducted.

As a test result, as shown in the dotted line portion in the left photo of FIG. 10, in the metal-composite specimen without the preheating, the composite tape 103 was partially separated. On the other hand, in the example of an experiment in which the metal 20 was preheated to 120° C. according to one embodiment, the composite tape 103 was not separated from the metal 20, and a fracture occurred in the adhesive for the structure. Therefore, in order to secure the bonding strength of the metal-composite specimen, it was confirmed that it may be advantageous to heat the metal 200 in advance using the second laser 20.

Referring to FIGS. 12A and 12B, various experiment examples of the metal-composite specimens to which the pre-heating process was applied may be confirmed. In the following, a unit MPa means the tensile strength of the metal.

As an embodiment, a Xenon beam is used as the composite heating apparatus 104, and the composite tape 103 was applied and bonded to the surface of the metal 200 plate from 1 to 3 layers to evaluate bending strength. In one of comparative examples, the 980 MPa metal 200 plate without the composite tape 103 applied, exhibited bending strength of 1700 N and the bending energy of 8.3 J. In one of comparative examples, the 1470 MPa metal 200 plate to which the composite tape 103 was not applied showed bending strength of 1900 N and bending energy of 7.9 J.

In the case of embodiment 1, the composite tape 103 including 50% by weight of the CFRP on the 980 MPa metal 200 plate applied to the surface of the metal 200 plate by 1 layer. The bending strength did not increase in this case and the bending energy increased by about 22% compared to the 980 MPa metal 200 plate without the composite tape 103.

In the case of embodiment 2, two layers of the composite tape 103 are applied to the surface of the metal 200 plate. In this case, the bending strength and the energy are slightly increased to 1745 N and 10.4 J, respectively, compared to embodiment 1, in which the composite tape 103 is coated with one layer. However, the lower bending strength showed a decrease compared to the plate material of the 1470 MPa metal without the applied composite tape 103.

In the case of embodiment 3, the composite tape 103 was applied in three layers to the metal 200 plate surface. In this case, the bending strength was 2020 N, which exceeded the bending strength value of the 1470 MPa plate without the composite tape 103 applied. Also, the bending energy was 12.1 J, which was about 46% higher than that of the 980 MPa metal 200 plate without the composite tape 103 and was about 53% higher compared to the 1470 MPa metal 200 plate without the composite tape 103. Therefore, it may be seen that the 1470 MPa steel plate may be replaced when three layers of the composite tape 103 are applied using the 980 MPa metal plate.

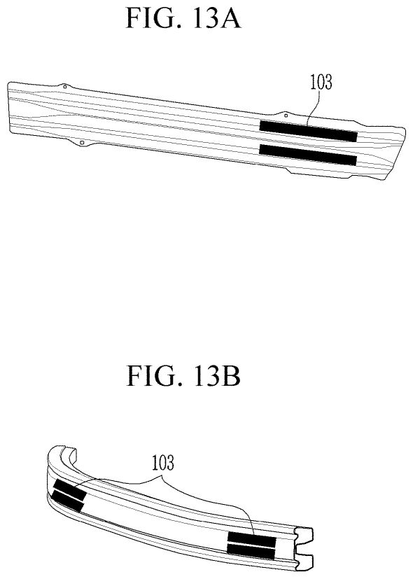

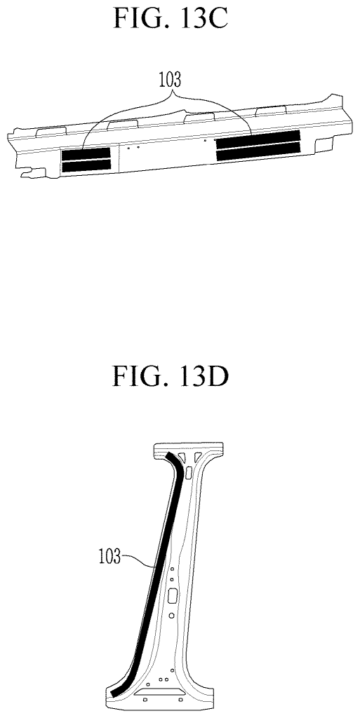

FIGS. 13A-13D are views showing examples of vehicle parts applied with manufacturing method according to an embodiment of the present disclosure.

Referring to FIGS. 13A-13D, the vehicle parts to which the manufacturing apparatus and manufacturing method for the metal-composite patch part according to the present disclosure are applied may include, but are not limited thereto, collision/strength parts such as door impact members (FIG. 13A), front bumper beams (FIG. 13B), side seal reinforcements (FIG. 13C), center pillar outer reinforcements (FIG. 13D), and the like. The door impact members are installed inside the door to safely protect the occupant in the event of a side impact of the vehicle. It is required to secure the impact stability despite a high tensile strength and a reduced volume and weight. The front bumper beams are the most important impact-absorbing part in the forward collision or small overlap collision. In the case of the side seal, it is a panel that replaces the frame at the bottom of the side of the vehicle. Because it is a panel at the bottom of the front and rear doors of an integrated vehicle body type without a frame, reinforcement is added to ensure the impact stability. The center pillar is a pillar that is installed in the left and right central portions of the vehicle to support the roof and maintain the door openings. Similarly, the reinforcement is added to ensure the impact stability. The embodiments of the present disclosure are applicable to the reinforcement.

Therefore, when applying the manufacturing apparatus and manufacturing method of the metal-composite patch part according to the present disclosure to the vehicle parts, there is no need to increase the entire material thickness of the collision part. The part that needs the collision reinforcement may be reinforced with the relatively light composite tape 103, so that the light weight objective of the vehicle may be achieved. In addition, the present disclosure is applicable to more vehicle parts that may benefit from adding the metal-composite structure and thus is not limited to the disclosed embodiments.

While this disclosure has been described in connection with what are presently considered to be practical embodiments, it is to be understood that the disclosure is not limited to the disclosed embodiments. On the contrary, the disclosure is intended to cover various modifications and equivalent arrangements included within the spirit and scope of the appended claims.

<Description of symbols>

| | |
|---|---|
| 1: laser oscillator | 10: first laser irradiator |
| 20: second laser irradiator | 100: metal-composite bonding |
| | apparatus |
| 101: pressing roller | 102: feeder roller |
| 103: composite tape | 104: composite heating apparatus |
| 200: metal | |

What is claimed is:

1. A manufacturing apparatus of a metal-composite patch part, the manufacturing apparatus comprising:
a laser oscillator oscillating a laser;
a first laser irradiator used to perform pattern processing on one surface of a metal with the laser by receiving the laser from the laser oscillator; and
a metal-composite bonding apparatus for bonding a composite tape to the one surface of the pattern-processed metal,
wherein the metal-composite bonding apparatus includes
a feeder roller supplying a composite tape to one surface of the pattern processed metal, and
a pressing roller pressing the composite tape to the one surface of the metal.

2. The manufacturing apparatus of claim 1, wherein
the laser is a pulse laser.

3. The manufacturing apparatus of claim 1, wherein
a shape of the one surface of the metal according to the pattern processing is defined according to an output of the laser and/or a pattern processing speed of the first laser irradiator.

4. The manufacturing apparatus of claim 3, wherein
the output of the laser is 70 W or more and 120 W or less.

5. The manufacturing apparatus of claim 3, wherein
the pattern processing speed of the first laser irradiator is 700 mm/s or more and 1000 mm/s or less.

6. The manufacturing apparatus of claim 1, wherein
the metal-composite bonding apparatus further includes a composite heating device for heating the composite tape before pressing the composite tape to the one surface of the metal.

7. The manufacturing apparatus of claim 6, wherein
the composite heating device is a Xenon beam.

8. The manufacturing apparatus of claim 1, wherein
the composite tape includes more than 40% by weight and less than 100% by weight of a carbon fiber reinforced plastic (CFRP) relative to an entire weight thereof.

9. The manufacturing apparatus of claim 1, further comprising
a second laser irradiator for pre-heating an opposite surface of the pattern-processed metal by receiving the laser oscillated from the laser oscillator.

10. A manufacturing method of a metal-composite patch part, the manufacturing method comprising:
transmitting a first laser from a laser oscillator to a first laser irradiator;
irradiating the first laser while moving the first laser irradiator on one surface of a metal for performing pattern processing to the one surface of the metal; and
bonding a composite tape on the one surface of the pattern-processed metal,
wherein the composite tape is supplied to the one surface of the metal through a feeder roller, and
the composite tape is pressed to the one surface of the metal through a pressing roller.

11. The manufacturing method of claim 10, wherein
the first laser is a pulse laser.

12. The manufacturing method of claim 10, wherein
an output of the first laser is controlled to 70 W or more and 120 W or less.

13. The manufacturing method of claim 10, wherein
a pattern processing speed of the first laser is controlled to be 700 mm/s or more and 1000 mm/s or less.

14. The manufacturing method of claim 10, wherein
before pressing the composite tape to the one surface of the metal through the pressing roller,
the composite tape is heated by using a composite heating apparatus.

15. The manufacturing method of claim 14, wherein
the composite heating apparatus is a Xenon beam.

16. The manufacturing method of claim 10, wherein
the composite tape includes more than 40% by weight and less than 100% by weight of a carbon fiber reinforced plastic (CFRP) relative to an entire weight thereof.

17. The manufacturing method of claim 10, further comprising
pre-heating an opposite surface to the one surface of the pattern-processed metal by receiving a second laser oscillated from the laser oscillator from a second laser irradiator.

18. The manufacturing method of claim 17, wherein
in the preheating, a position of the second laser irradiator is adjusted to irradiate the second laser at a distance of 0 mm or more and 10 mm or less from a center of the pressing roller.
